(19) United States
(12) Patent Application Publication
(10) Pub. No.: US 2025/0368425 A1
(43) Pub. Date: Dec. 4, 2025

(54) REUSABLE CONTAINER FOR FROZEN PRODUCTS

(71) Applicant: SOCIETE DES PRODUITS NESTLE S.A., VEVEY (CH)

(72) Inventor: Tommy See Tho, Selangor Darul Ehsan (MY)

(21) Appl. No.: 19/300,115

(22) Filed: Aug. 14, 2025

Related U.S. Application Data
(63) Continuation of application No. 17/283,674, filed on Apr. 8, 2021.
(60) Provisional application No. 62/744,891, filed on Oct. 12, 2018.

(51) Int. Cl. B65D 81/38; B65D 85/78

(52) U.S. Cl. CPC B65D 81/3841; B65D 85/78

(57) ABSTRACT

A method stores or transports a frozen food composition in a reusable container. The method includes receiving the food composition in a first container, the first container comprising an opening and a bottom, and a portion of the first container has a frustoconical shape. The method also includes attaching a first lid to the first container to cover the opening in a closed position in which the first lid closes off the opening of the first container. The method further includes forming an air gap between the first container and a first jacket, by moving a fastening member into an engaged position that engages the first jacket to at least one of the first container with a frozen food composition therein or the first lid on the first container with the first frozen food composition therein. The first container, the first lid and the first jacket are separate parts in a non-engaged position of the fastening member. The fastening member, in the engaged position where the fastening member engages the first jacket to the at least one of the first container or the first lid on the first container, does not hermetically seal the air gap that is created between the first container and the first jacket. The method yet further includes causing a convection of air between a wall of the first jacket and the portion of the first container having the frustoconical shape, while the fastening member is in the engaged position, whereby the air receives heat transfer from the wall of the first jacket and rises along the wall of the first jacket towards a wall of a top half of the first container, the air then cools down due to a temperature of the frozen food composition and begins to move downwards along the wall of the first portion of the first container toward the bottom of the first jacket where the air is heated up again, thereby causing a circulation of the air.

### CROSS REFERENCE TO RELATED APPLICATIONS

The present application continuation of U.S. patent application Ser. No. 17/283,674 filed Apr. 8, 2021, which is a National Stage of International Application No. PCT/EP2019/077558 filed Oct. 11, 2019, which claims priority to U.S. Provisional Patent Application No. 62/744,891 filed Oct. 12, 2018, the entire contents of which are being incorporated herein by reference.

### FIELD OF THE INVENTION

This invention relates to reusable food packaging, in particular to a food packaging for frozen products such as frozen confectionery.

### BACKGROUND

A great variety of packaged convenience foods are available to a consumer. However, there is a growing need for sustainable packaged food.

Traditionally ice cream tubs are made from paper carton with a paper carton lid. The cartons and lid are covered with a thin plastic coating. The tubs and lids may also be made from plastics. The tub after being filled is closed with a foil which is sealed onto the tub. The lid is then placed on the ice cream tub. To open the ice cream tub the lid and subsequently the foil are removed. Once emptied the tubs are thrown out and cannot be re-used. For many of these tubs the packaging material cannot be re-used or recycled due to the combination of materials used.

It is well known that when frozen confectionery in paper carton or plastic tubs are taken directly from the freezer and served, its texture tend to be hard and scooping difficult. The frozen confectionery tub is therefore often taken out of the freezer prior to serving and then left to soften before served. This does, however, have the disadvantage that part of the frozen confection which is not eaten or scooped immediately then becomes too soft or melted compromising the quality of the product.

There is therefore a need for a frozen confectionery package which provides a soft but not melted texture across its consumption period.

There is also a need for sustainable packaging solutions for frozen products such as frozen confectionery.

### OBJECT OF THE INVENTION

It is the object of present invention to provide packaging for frozen products which provides a solution to one or more or all of the above-mentioned needs.

### SUMMARY

The present invention provides the improvement by reusable container for frozen compositions with a particular design that provides a gradual insulation of the frozen composition while the container can be dismantled and reassembled to allow fast freezing of the product, and easy cleaning of the container.

In a first aspect, the invention relates to a reusable container for storing or transporting a frozen food composition comprising:
a first container for receiving the food composition, the first container comprising an opening and a bottom,
a first lid configured to attach to the first container to cover the opening, and which has a closed position in which the first lid closes off the opening of the first container,
a first jacket; and
fastening means which has an engaged position wherein the fastening means engages the first jacket to at least one of (a) the first container with a frozen food composition therein or (b) the first lid on the first container with the first frozen food composition therein; and wherein the engaged position of the fastening means forms an air gap between the first container and the first jacket, and wherein the first container, the first lid and the first jacket are separate parts in a non-engaged position of the fastening means.

In a second aspect, the invention relates to a reusable packaging comprising a reusable container as described above, wherein the reusable container is packed in a reusable insulating tote.

One advantage of the container according to the present invention is that freezing of a food composition in the first container with a lid can be done before the first jacket is attached. This allows a faster and efficient freezing and reduces the energy required for the freezing.

Another advantage of the reusable container according to the invention is that it can be cleaned and re-used. The reusable container is particular useful for frozen food composition such as a frozen confectionery.

A further advantage of the reusable container according to the invention is that it can be used for providing a consumer with a frozen food composition at their home without the need to visit a grocery store or other retail establishment away from the home. This is because the container is suitable for shipment and that the shipment can be done without melting of the product. Furthermore, since the parts of the container can be re-used in multiple fillings, freezing and shipment of a frozen food composition waste is minimized.

In addition to the above-mentioned advantages, the container according to the invention provides a slow melting experience to the consumer during consumption while the frozen food composition at the top of the container is soft when the container is opened.

It has been found, that with the reusable container according to the invention inside a tote, the tote can stay at ambient temperature 24 hours with the frozen confection still frozen inside the container.

Additional features and advantages are described herein and will be apparent from the following Figures and Detailed Description.

### BRIEF DESCRIPTION OF THE DRAWINGS

In the drawings which illustrate example embodiments of this invention:

FIG. 1 is an exploded perspective view of a container according to the invention. FIG. 1 shows a container (A) according to the invention comprising a first container (E), a first lid (F), a first jacket (C), and fastening means (B), (D) and (G).

FIGS. 2A, 2B, and 2C are perspective, top and side views of the lid (F) in FIG. 1.

FIGS. 3A and 3C are detailed side views of fastening means (B) and (G) in FIG. 1.

FIG. 3B is a side view of jacket C in FIG. 1.

FIG. 3D is a side view of fastening means D in FIG. 1.

FIG. 3E is a side view of the first container E in FIG. 1.

FIG. 4 is a cross section view of the container according to the invention.

FIG. 4 shows a cross section of the first container, the first lid and the first jacket in an joint configuration.

FIG. 5 is a principle drawing showing the supply and re-use of the containers according to the invention.

FIG. 6 shows the temperature distribution in the container according to the invention over time.

### DETAILED DESCRIPTION

With the container according to the invention, it is possible to re-use one or more food containers, jackets for the food containers, or lids for the containers and/or the jackets. For example, a food composition made at a factory can be provided in a first delivery to a consumer, and then after the first delivery, one or more of the corresponding articles (e.g. the container, the jacket and/or the lid) can be collected, washed and re-used (e.g. re-filled with another food composition).

The container and/or the jacket and/or the lid are preferably made from metal such as stainless steel to allow a high temperature cleaning and provide food safety when re-used.

In the present context, the term “food composition” means a composition that is intended for digestion by an individual, such as a human or a companion animal, and provides at least one nutrient to the individual. Further, in the present context, the term “frozen confectionery” refers to any frozen or chilled confection. Non-limiting examples are ice cream, sorbet, sherbet, water ice, frozen yogurt, frozen dairy, soft ice, granitas, mellorine, frozen custard, non-dairy frozen confection, milk ice, ice lolly, gelato or frozen jelly, or chilled desserts such as mousses, whipped yogurt, milk shakes or smoothie or coffee latté.

In a preferred embodiment of the invention, the reusable container has an air gap between the first container and the first jacket that increases towards the bottom of the first container when the fastening means are in the engaged position.

It is further preferred that at least a portion of the first jacket comprises an inner surface having a shape complementary to the outer surface of at least a portion of the first container such that the outer surface of the first container at least partially abuts the inner surface of the first jacket when engaged.

The advantage of the increasing air gap provides an increased insulation of the bottom of the first container while the portion of the container not having any air gap when the lid is removed speed up the melting of the exposed part of the frozen food composition.

In one embodiment of the reusable container according to the invention the first container has a circular cross-section in at least one part of the first container selected from the group consisting of (i) an opening of the first container covered by the first lid, (ii) a planar bottom of the first container, and (iii) one or more horizontal planes substantially perpendicular to an axis of symmetry of the first container and substantially parallel to at least one of the opening of the first container or the planar bottom of the first container.

Advantageously, the reusable container according to the invention has at least a portion of the first container, which comprises an outer surface having a frustoconical shape such that a diameter of the circular cross-section within the frustoconical shape continuously decreases as the distance of the circular cross-section from the planar bottom of the first container decreases. This provides the advantage that the food composition at the lower part of the container will melt more slowly than the frozen food composition at the top of the container thus presenting the product composition at the bottom of being too soft even if left at ambient for a period.

In an alternative embodiment, the reusable container according to the invention has a first container that has a square or rounded cross-section in at least one part of the first container selected from the group consisting of (i) an opening of the first container covered by the first lid, (ii) a planar bottom of the first container, and (iii) one or more horizontal planes substantially perpendicular to an axis of symmetry of the first container and substantially parallel to at least one of the opening of the first container or the planar bottom of the first container. In this embodiment at least a portion of the first container, which comprises an outer surface having a complementary shape the size of which continuously decreases as the distance of the square or rounded cross-section from the planar bottom of the first container decreases.

In a preferred embodiment of the invention, the reusable container according to any of the preceding claims, wherein the fastening means comprises at least one receiving portion selected from the group consisting of (i) a receiving portion for receiving a portion of the first lid in a complementary portion of the first jacket and (ii) a receiving portion for receiving a portion of the jacket in a complementary portion of the first i lid.

It is preferred that the fastening means comprises a least one receiving portion selected from the group consisting of (i) a receiving portion for receiving a portion of the first container in a complementary portion of the first jacket and (ii) a receiving portion for receiving of the jacket in a complementary portion of the first container.

The receiving portion or portions may be selected from the group consisting of screw thread or threads; complementary holes and plugs, click lock or locks or a combination thereof.

Preferably, the first container, the lid and the first jacket are made from a material selected from the group consisting of metal, plastics, ceramics, porcelain or a combination thereof. In a particular preferred embodiment of the invention the first container, the lid and the first jacket are made from stainless steel. This allows the container parts of the container according to the invention to be cleaned according to certification by the authorities' and food safety. The containers may e.g. be used for allergen free products.

Preferably, the first container, the first lid and the first jacket are constructed such that they do not retain water after the washing. As a non-limiting example, the washing can comprise ultra-sonic cleaning such as a pH 12 ultra-sonic bath; and the first container, the first lid and the first jacket can comprise or consist of materials that can withstand such washing. However, the present disclosure is not limited to a specific embodiment of the washing, and the washing can be any means known in the art that reduces the residual material on the components.

Furthermore, depending on the material used for the container, the container may be suitable for microwave heating. This is e.g. the case when the container is made from a material selected from the group consisting of plastics, ceramics, porcelain or a combination thereof. If the frozen food composition is e.g. a frozen meal or soup the food composition can be prepared e.g. heated directly in the container in a microwave oven.

In a preferred embodiment of the reusable container according to the invention the fastening means is an integrated part of at least one of the first container, the lid and the first jacket and the fastening means are joined thereto, preferably by welding or clamping.

In one embodiment of the invention the first lid and/or the first jacket is provided with insulation material.

Preferably, the fastening means does not hermetically seal the air gap that is created between the first container and the first jacket. Without wishing to be bound by theory, it is believed that as hot air rises and cool air descends, the increasing gap of air down the container will allow the heat transfer to happen from top to bottom. The increased air gap at the bottom of the container ensures that the rate of the heat transferred between the wall of the first jacket and the wall of the first container is lower at the bottom half of the first container versus the top half of the container. Coupled with the knowledge that hot air tends to rise and cool air tends to descend, this causes a convection of air whereby the heated air by the wall of the first jacket will rise along the wall and towards the wall of the top half of the first container. The air will then cool down due to the product temperature and begin to move downwards along the wall of the first container toward the bottom of the first jacket where it will then be heated up again causing a circulation of the air.

The invention also relates to a reusable packaging comprising a reusable container as discussed in the above-mentioned embodiments wherein the reusable container is packed in a reusable insulating tote. The insulated tote can comprise a bag into which one or more insulated plates are inserted, such as a bottom insulated plate and/or one or more side insulated plates. In an embodiment, the insulated tote can have a height up to nine inches and/or a width up to six inches.

The container according to the invention can be used in a method of providing a frozen food composition directly to a consumer, the method comprising: providing a first container; dispensing at least one comestible ingredient into the first container; positioning a first lid on the container containing the at least one comestible ingredient; freezing the container with the lid thereon and the at least one comestible ingredient therein to form the frozen food composition in the container, wherein at least one step is performed at a first location and is selected from the group consisting of (i) the dispensing of the at least one comestible ingredient, (ii) the positioning the lid on the container, and (iii) the freezing of the container; transporting the container with the frozen food composition therein from the first location to an intermediate location; attaching the first jacket to at least one of (a) the container with the frozen food composition therein or (b) the lid on the container with the frozen food composition therein, the attaching of the jacket is performed at the intermediate location; and transporting the frozen food composition from the intermediate location to a home of the consumer is by transporting the container in the jacket.

The container according to the present invention has the advantage that the freezing of the comestible ingredients in the first container with a lid can be done before the first jacket is attached. This allows a faster freezing and reduces the energy needed. This also allows for easy frozen distribution to a location closer to the consumer where the first jacket can be attached to the first container or the lid. Once the jacket is attached the air gap provides an insulation which is more pronounced for the lower part of the container. Thus providing the temperature gradient which results in a even softness of the product during consumption.

The method in which the container according to the invention can be used can comprise a re-using of the cleaned components such as the cleaned containers, the cleaned lids and the cleaned jackets (e.g. the cleaned first container, the cleaned first lid and the cleaned first jacket. In this regard, any of the process steps can be performed again, but using one or more of the cleaned components. For example, a cleaned container can receive a new dispensing of the one or more comestible ingredients, then a cleaned lid can close the container (not necessarily the same lid as previously utilized on the cleaned container), then freezing thereof can form a new frozen food composition in the container, then transporting of the container to the intermediate location can allow a cleaned jacket to be applied (not necessarily the same jacket as previously utilized on the cleaned container, not necessarily the same jacket as previously utilized with the cleaned lid, and not necessarily the same intermediate location as previously utilized for the cleaned container), and then the jacketed container holding the new frozen food composition can be transported to a consumer.

### EXAMPLES

By way of example and not limitation, the following examples are illustrative of various embodiments of the present disclosure.

### Example 1

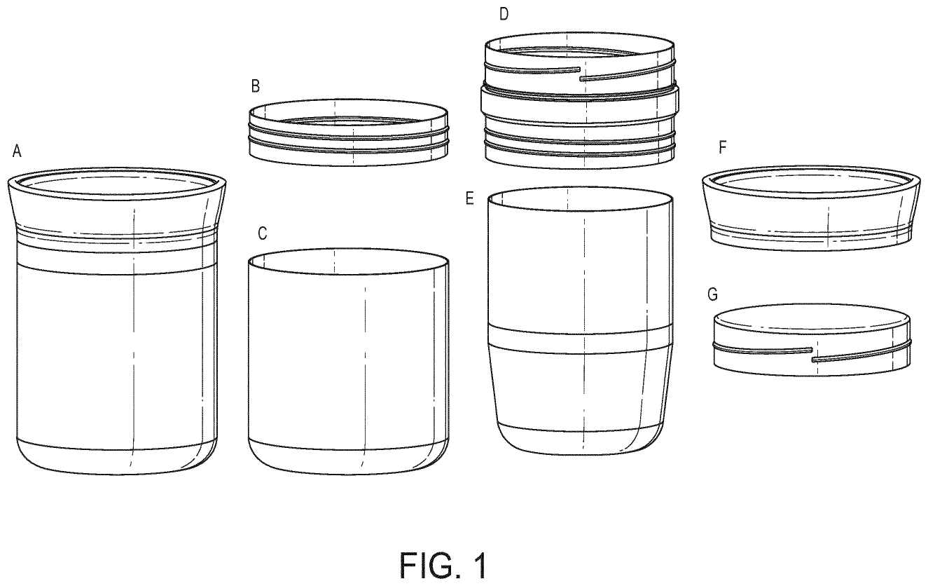

FIG. 1 is an exploded perspective view of a container according to the invention. FIG. 1 shows a container (A) according to the invention comprising a first container (E), a first lid (F), a first jacket (C), and fastening means (B), (D) and (G).

FIG. 1 shows a container (A) according to the invention wherein the parts thereof are assembled. The fastening means (B) is arranged inside the first jacket (C). The fastening means (D) arranged on the outside of the first container (E) and the fastening means (G) is arranged in the side the first lid (F). In the assembled position, the first jacket (C) is attached to the first container (E) by means of fastening means (B) and (D) and the first lid is attached to the first container (E) by means of the fastening means (D) and (G).

The fastening means in FIG. 1 are shown as separate parts. However, the fastening means may be integrated parts of the first container, the lid and the first jacket respectively. The fastening means are preferably welded or clamped onto the first container, the lid and the first jacket. Alternatively, the fastening means may be moulded in one piece therewith the first container, the first lid and the first jacket respectively.

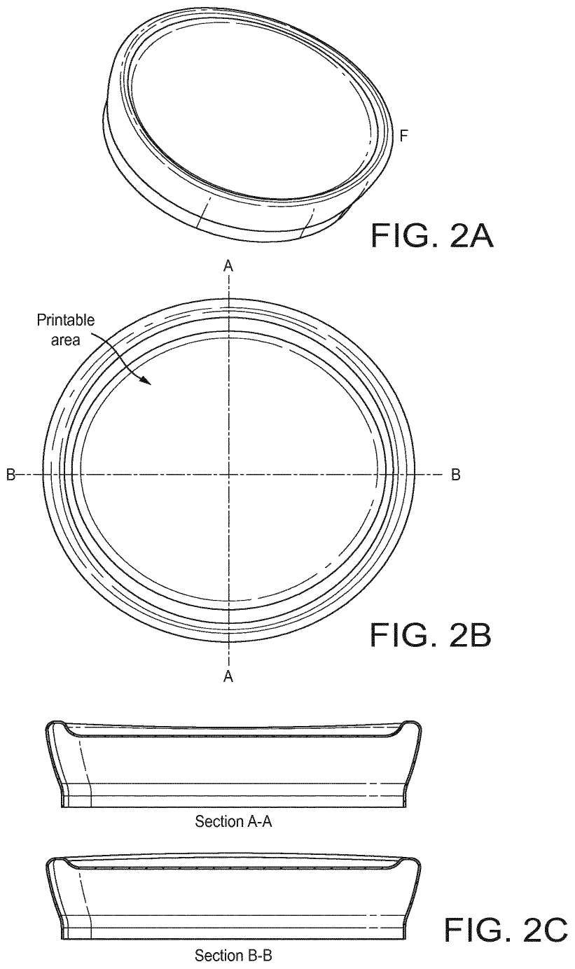

FIGS. 2A, 2B, and 2C are perspective, top and side cross-section views of the lid (F) in FIG. 1. The lid in this embodiment has a flat upper area which is suitable for printing or attachment of a label e.g. with information about the frozen product's shelf life, ingredients etc.

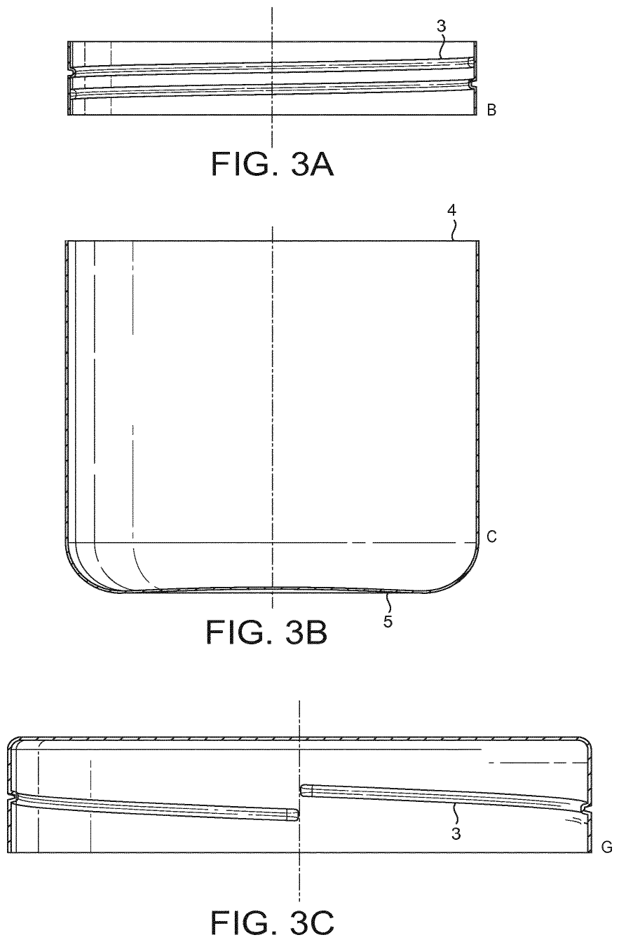

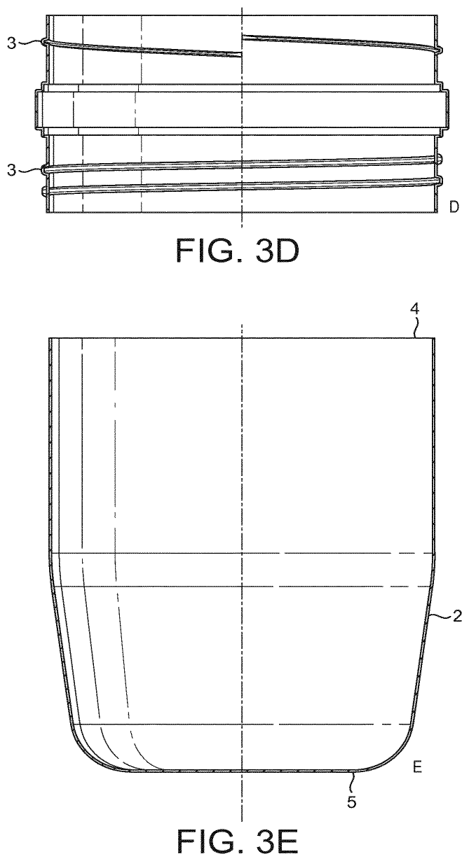

FIGS. 3A and 3C are detailed cross-section side views of fastening means (B) and (G) in FIG. 1. FIG. 3B is a side view of jacket (C) while FIG. 3D is a side view of fastening means D in FIG. 1.

The fastening means (B) in FIG. 3A comprises a receiving portion for receiving a portion of the first container in a complementary portion of the first jacket. The fastening means is preferably an integrated part of the first jacket (C).

The fastening means (G) for the lid in FIG. 3C comprises a receiving portion for receiving a portion of the first container in a complementary portion of the fastening means. The fastening means is preferably an integrated part of the first lid (F).

The upper parts of the fastening means (D) in FIG. 3D has a receiving portion for receiving a portion of the first lid in a complementary portion of the first lid. The lower part of the fastening means (D) has a receiving portion for receiving a portion of the first container in a complementary portion. The fastening means (D) are preferably an integral portion of the first container. In the embodiment shown in the figures the fastening means are screw threats and corresponding screw engravings. This is a preferred embodiment of the fastening means.

FIG. 3E is a side view of the first container (E). FIG. 3E shows a first container having a circular cross-section in the opening 4 which when closed is covered by the first lid. The first container also has a planar bottom 5 and horizontal planes substantially perpendicular to an axis of symmetry of the first container and substantially parallel to the opening of the first container and the planar bottom 5 f the first container.

FIG. 3E also shows a first container (E) having a portion of the first container comprises an outer surface having a frustoconical shape 2 where the circular cross-section within the frustoconical shape continuously decreases as the distance of the circular cross-section from the planar bottom 5 of the first container decreases.

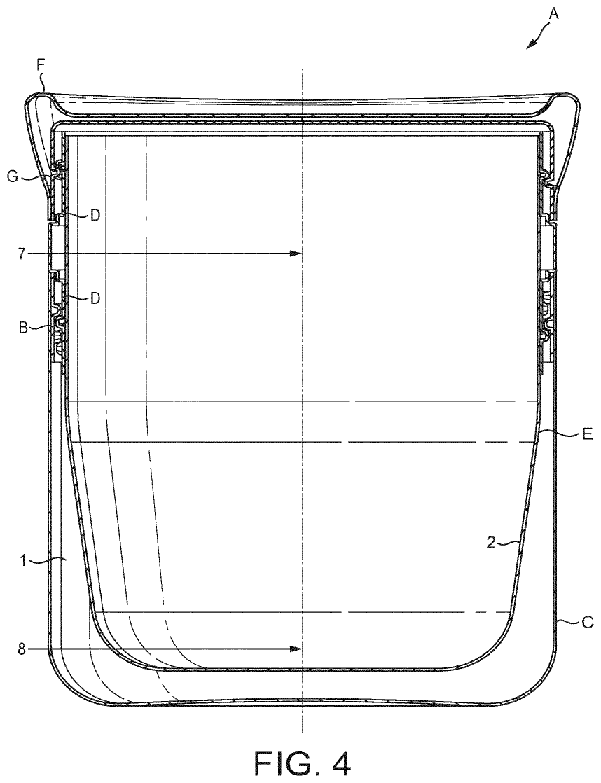

FIG. 4 is a cross section view of the container according to the invention.

FIG. 4 shows the a cross section of the first container, the first lid and the first jacket in an joint configuration.

FIG. 4 is showing the increasing of the air gap (1) between the first jacket (C) and the first container (E). The air gap is created around the first container when reusable container is closed to minimize the heat transfer during transportation. It has been found that the container according to the invention positioned in an isolating tote can be kept at ambient temperature 24 hours or longer without the frozen product therein melting.

A portion of the first jacket (C) comprises an inner surface having a shape complementary to the outer surface of at least a portion of the first container such that the outer surface of the first container at least partially abuts the inner surface of the first jacket when engaged. In the embodiment in FIG. 4 the fastening means are integrated parts of the first packet and the first container respectively. The abutting fastening means provides the inner surface of the first jacket and the out surface of the first container.

### Example 2

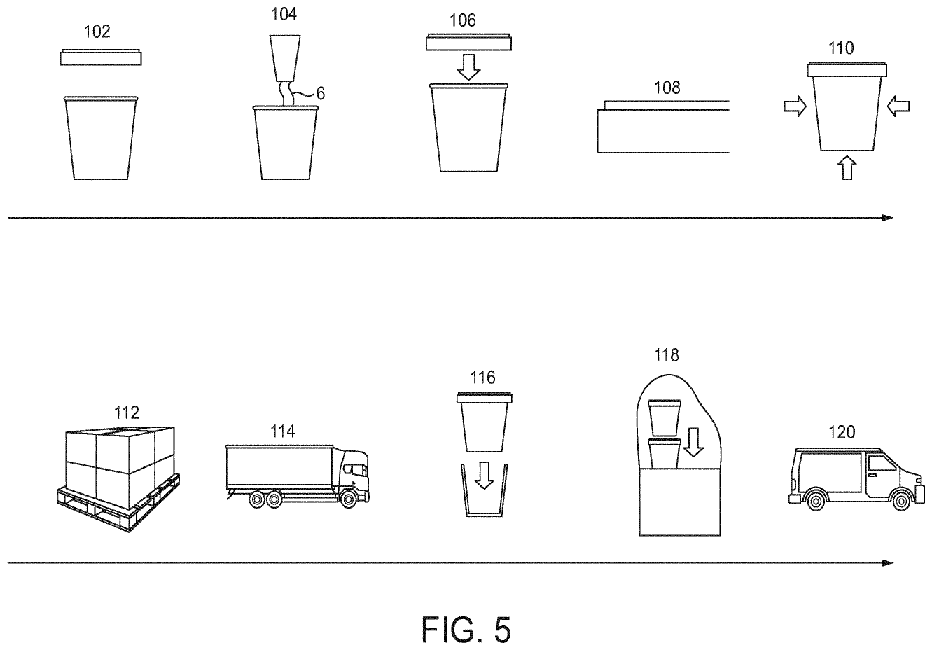

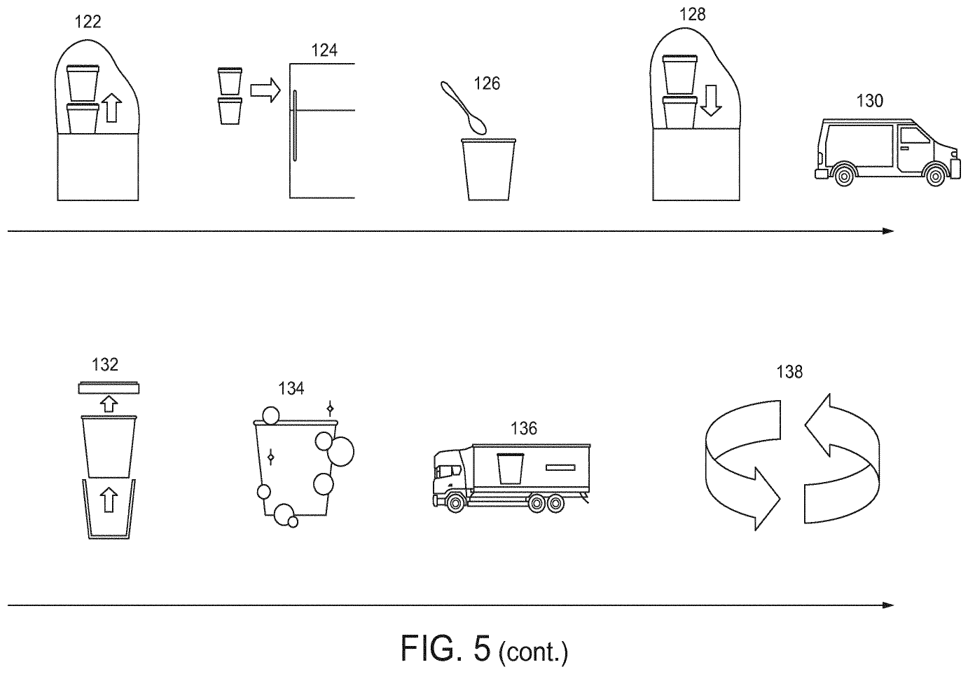

FIG. 5 is a principle drawing showing the method of supply and re-use of the containers according to the invention.

The method comprises providing a first container and/or a first lid (Step 102). The method comprises dispensing at least one comestible ingredient/food composition into the first container preferably from one or more nozzles 21 (Step 104). The first container can be provided as part of a plurality of containers, and preferably the at least one frozen composition ingredient is dispensed into each of the plurality of containers. A lid is then positioning on the first container containing the frozen composition (Step 106). The method can comprise providing printing indicia on at least one of the first lid and/or the first container containing the food composition; the indicia can comprise at least one of a batch code or an expiry date (Step 108). In the next step of the method, the first container with the first lid thereon and the at least one food composition therein is frozen to form a first frozen food composition in the first container (Step 110).

Then the method can comprise packaging the plurality of containers holding the frozen food compositions with the lids thereon (e.g., the first container with the first frozen food composition therein and the first lid thereon) into larger containers, such as shipping boxes (Step 112). Then the method comprises transporting the plurality of containers holding the frozen food compositions with the lids thereon (e.g., the first container with the first frozen food composition therein and the first lid thereon) from the first location, such as a factory, to an intermediate location that is a different location than the first location, such as a distribution centre (Step 114). Then the first jacket on the first container with the first frozen food composition therein are positioned at the intermediate location (Step 116). In the intermediate location the first jacket is attach to the first container. The method then comprise positioning the plurality of jackets (e.g., the first jacket) holding the plurality of containers (e.g., the first container) in an insulated tote, preferably at the intermediate location (Step 118). The method then comprise transporting the first container with the first frozen food composition therein and the first lid and the first jacket thereon from the intermediate location to a second location, that is a different location than the first and intermediate locations, for example a home of a consumer (Step 120).

In FIG. 5 the method comprises removing the first container holding the first frozen food composition from the insulated tote at the second location, e.g., the home of the consumer (Step 122). One or more containers are then removed from the insulated tote at the second location into a refrigerator or freezer at the second location (Step 124). The consumer is then consuming the first frozen food composition from the first container at the second location (Step 126). The consumer is then placing the first container back in the insulated tote (Step 128).

The method further comprises transporting the first container partially empty or completely empty container and the first lid and the first jacket thereon from the second location back to the intermediate location (Step 130). At the intermediate location the first jacket, the first container and the first lid are separated from each other, e.g. at a distribution center (Step 132). The method then comprise washing the first container, the first lid and the first jacket that have been separated from each other, preferably at the intermediate location. The method then can comprise transporting the cleaned first container and the cleaned first lid from the intermediate location (e.g., the distribution centre) to the first location (e.g., the factory), preferably while the cleaned first jacket is kept at the intermediate location (Step 136). The method the comprises re-using the cleaned components such as the cleaned containers, the cleaned lids and the cleaned jackets (e.g., the cleaned first container, the cleaned first lid and the cleaned first jacket) (Step 138).

### Example 3

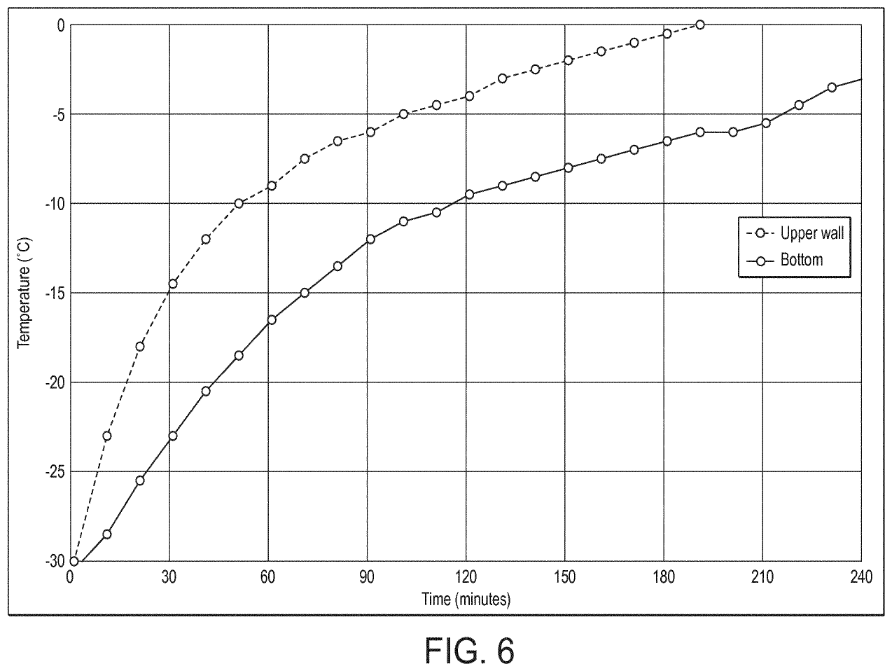

FIG. 6 shows the temperature distribution in the container according to the invention over time. From the same starting point, the bottom of the containers show a slower increase in temperature versus the temperature at the top of the container.

The temperature distribution was measure on a container according to the invention. A container according to the invention, comprising bulk vanilla ice cream, was provided with one temperature probe taped to the wall approx. 2 cm from the top, and another taped to the bottom. Sensor surfaces faced inward and was placed in meltdown analyser chamber with a constant temperature of 22° C. The position of the upper wall temperature probe 8 and the bottom temperature probe 9 are shown in FIG. 4.

It was found that warming was slower at the bottom of the container provided by the insulation properties of the container and the direct abutting portions of the first container and the jacket, provides an ability of the container to deliver a slow melting experience to the consumer during consumption.

The hatched line in FIG. 6 shows the temperature evolution on the upper part of the container while the full line shows the temperature evolution on the bottom part of the container. FIG. 6 shows a difference between the temperature of the upper part of the container and the bottom of the container across time demonstrating the specific insulation properties designed to deliver a soft ice cream across its consumption.

It should be understood that there are various changes and modifications to the presently preferred embodiments described herein which will be apparent to those skilled in the art. Such changes and modifications can be made without departing from the spirit and scope of the present subject matter and without diminishing its intended advantages. It is therefore intended, that such changes and modifications be covered by the appended claims.
(A) container according the invention
(B) fastening means for first jacket (C)
(C) first jacket
(D) fastening means for the first container
(E) first container
(F) first lid
(G) fastening means for the first lid
1 air gap
2 conical surface
3 screw threats/receiving portions
4 opening
5 bottom
6 froze confection
8 upper wall temperature probe
9 bottom temperature probe

1: A method of storing or transporting a frozen food composition in a reusable container, the method comprising:
receiving the food composition in a first container, the first container comprising an opening and a bottom, and a portion of the first container has a frustoconical shape;
attaching a first lid to the first container to cover the opening in a closed position in which the first lid closes off the opening of the first container;
forming an air gap between the first container and a first jacket, by moving a fastening member into an engaged position that engages the first jacket to at least one of the first container with a frozen food composition therein or the first lid on the first container with the first frozen food composition therein, and wherein the first container, the first lid and the first jacket are separate parts in a non-engaged position of the fastening member,
wherein the fastening member, in the engaged position wherein the fastening member engages the first jacket to the at least one of the first container or the first lid on the first container, does not hermetically seal the air gap that is created between the first container and the first jacket; and
causing a convection of air between a wall of the first jacket and the portion of the first container having the frustoconical shape, while the fastening member is in the engaged position, whereby the air receives heat transfer from the wall of the first jacket and rises along the wall of the first jacket towards a wall of a top half of the first container, the air then cools down due to a temperature of the frozen food composition and begins to move downwards along the wall of the first portion of the first container toward the bottom of the first jacket where the air is heated up again, thereby causing a circulation of the air.

2: The method according to claim 1, wherein a horizontal distance of the air gap between the first container and the first jacket increases towards the bottom of the first container when the fastening member is in the engaged position.

3: The method according to claim 1, wherein the first container has a circular cross-section in at least one part of the first container selected from the group consisting of an opening of the first container covered by the first lid, the bottom of the first container, and one or more horizontal planes substantially perpendicular to an axis of symmetry of the first container and substantially parallel to at least one of the opening of the first container or the bottom of the first container.

4: The method according to claim 1, wherein a diameter of a circular cross-section within the frustoconical shape continuously decreases as a distance of the circular cross-section from the bottom of the first container decreases.

5: The method according to claim 1, comprising receiving a portion of the first lid in a complementary portion of the first jacket.

6: The method according to claim 1, comprising receiving a portion of the first container in a complementary portion of the first jacket.

7: The method according to claim 1, wherein the first container, the lid and the first jacket are made from a material selected from the group consisting of metal, plastics, ceramic, porcelain and a combination thereof.

8: The method according to claim 1, wherein the first container, the lid and the first jacket are made from stainless steel.

9: The method according to claim 1, wherein the fastening member is an integrated part of at least one of the first container, the lid and the first jacket, and the fastening member is joined to the at least one of the first container, the lid and the first jacket.

10: The method according to claim 1, further comprising packing the reusable container in a reusable insulating tote.
